(19) United States
(12) Patent Application Publication
(10) Pub. No.: US 2012/0098183 A1
(43) Pub. Date: Apr. 26, 2012

(54) UNIVERSAL FENCE ASSEMBLIES FOR POWER TOOL TABLES HAVING MULTI-POSITION STOP ASSEMBLIES

(75) Inventor: Tom Benton Sharp, Jackson, TN (US)

(73) Assignee: Black & Decker Inc., Newark, DE (US)

(21) Appl. No.: 12/908,137

(22) Filed: Oct. 20, 2010

(51) Int. Cl. B23Q 3/02

(52) U.S. Cl. 269/315

(57) ABSTRACT

A fence assembly includes a fence body having front and rear faces that define a width and top and bottom faces that define a height of the fence body. The fence assembly includes at least one stop assembly, each stop assembly including a stop arm that is moveable from a first position in which the arm overlies one of the faces of the fence body and a second position in which the arm extends away from one of the faces. The fence body has a high-profile position in which the front and rear faces are perpendicular to a table and a low-profile position in which the front and rear faces are parallel with the table. The stop arm overlies one of the front and rear faces when the fence body is in the high-profile position and one of the top and bottom faces when the fence body is in the low-profile position.

### BACKGROUND OF THE INVENTION

1. Field of the Invention

The present invention generally relates to power tools having tables for supporting work pieces and more specifically relates to fences for power tool tables.

2. Description of the Related Art

Power tools, such as table saws, miter saws, router tables and drill presses, typically have tables that are used for supporting work pieces during cutting or drilling operations. Vertical fences are secured atop the table in order to stabilize the work pieces when cutting and drilling. The fence may include one or more clamps that enable the fence to be secured at a desired location on the table. In some instances, the position of the fence is adjustable between a rear edge and a front edge of the table.

Drill presses are used for drilling holes in work pieces such as sheet metal and wood. A drill press fence is used to stabilize a work piece on the table so that the work piece is accurately aligned with a drill bit. It is generally desirable to have the fence stand as high as possible to provide more stability for work pieces. Unfortunately, the use of fences on drill press tables causes a number of problems particularly associated with operating a drill press. A first problem arises when an operator seeks to drill holes near an edge of a work piece. In these instances, the drill chuck may hit the vertical fence as the drill bit is lowered toward the work piece.

A second problem arises due to the fact that drill press tables come in many different sizes and shapes. As a result, it may be difficult or impossible to fasten a standard fence to a top surface of a table. Moreover, even if the fence is secured to the table, the anchoring of the fence to the table may be unstable or wobbly.

In many instances, operators seek to drill a plurality of spaced holes along the length of a work piece. In order to accomplish this task, an operator may use a stop connected with a drill press fence. Unfortunately, the operator must move the stop each time he or she desires to form the next hole in the sequence. The process of continuously moving the stop can be both time consuming and inaccurate.

In view of the above deficiencies found in drill press fences, there remains a need for a fence assembly for a drill press that is able to be securely fastened to a wide variety of tables having different shapes and sizes. There also remains a need for a fence assembly for a drill press that enables the fence to be secured to any desired location on a table. In addition, there remains a need for a fence assembly for a drill press that provides excellent stability for drilling holes in taller work pieces while enabling operators to drill holes near an edge of a work piece without the drill chuck contacting the fence as the drill bit is lowered. There also remains a need for a fence assembly for a drill press including a stop assembly that enables operators to accurately and efficiently drill a plurality of spaced holes along the length of a work piece without requiring the operator to continuously reposition the stop.

### SUMMARY OF THE INVENTION

In one embodiment, a fence assembly for a power tool having a work piece supporting table preferably includes a fence body securable to the table, the fence body having a front face, a rear face, a top face and a bottom face. The distance between two planes parallel with the top and bottom faces defines a height of the fence body, and the distance between two planes parallel with the front and rear faces defines a width of the fence body. The fence body is preferably made of a rugged material such as metal. In one embodiment, the fence body is made of extruded aluminum.

The fence assembly desirably includes at least one stop assembly that is securable to the fence body. Each stop assembly desirably includes a stop arm that is moveable from a first position in which the stop arm overlies one of the fence body faces for functioning as a stop and a second position in which the stop arm extends away from one of the fence body faces and does not function as a stop. In one embodiment, the stop arm is rotatable between the first and second positions. In one embodiment, the stop arm is flipped between the first and second positions.

In one embodiment, the fence assembly includes a plurality of stop assemblies that may be secured along the length of the fence body. The exact spacing between the stop assemblies may be adjusted by an operator. In one embodiment, a plurality of stop assemblies is positioned in series along the length of the fence body. The stop arm of each stop assembly desirably overlies one of the fence body faces for providing a series of stops. An operator may drill a series of holes in a work piece by abutting an edge of the work piece against a first stop arm. When the first hole has been drilled, the operator may move the stop arm up and away from the table into the second position so that the stop arm is not functioning as a stop and the edge of the work piece may be advanced along the fence body to the second stop arm. The second hole may then be drilled in the work piece, the second hole being spaced from the first hole. The operator may then move the second stop arm up and away from the table into the second position so that the work piece may be advanced toward the third stop arm. This process may be repeated until a plurality of spaced holes are accurately and efficiently drilled into the work piece.

In one embodiment, the fence body is securable to the table in a first high-profile position in which the front and rear faces of the fence body are perpendicular to a top surface of the table and the top and bottom faces of the fence body are parallel with the table top surface. The fence body is securable in a second low-profile position in which the front and rear faces of the fence body are parallel with the table top surface and the top and bottom faces of the fence body are perpendicular to the table top. Although the present invention is not limited by any particular theory of operation, it is believed that securing the fence body in the high-profile position will enable an operator to stand a work piece on its edge and provide more stability for taller work pieces. The low-profile position for the fence body is more desirable for forming holes near an edge of a work piece while minimizing the likelihood that a drill chuck will hit the fence when lowered for forming a hole in the work piece. An operator may select whether the fence body is used in the high-profile position or the low-profile position depending upon the type of work piece being drilled or the operational needs of the user.

In one embodiment, the fence body top face preferably has a first elongated slot formed therein for slideably coupling the at least one stop assembly with the fence body when the fence body is in the high-profile position. The fence body rear face preferably has a second elongated slot formed therein for slideably coupling the at least one stop assembly with the fence body when the fence body is in the low-profile position. In one embodiment, the elongated slot that is not being used for the stop assembly may be used for a clamping assembly.

In one embodiment, the stop arm on the at least one stop assembly is preferably adapted to overlie one of the front and rear faces of the fence body when the fence body is in the high-profile position, and overlie one of the top and bottom faces of the fence body when the fence body is in the low-profile position.

In one embodiment, the at least one stop assembly also preferably includes a stop arm extension that is attachable to the stop arm for extending the length of the stop arm for use when the fence is in the high-profile position. In one embodiment, the stop arm extension is desirably attachable to a lower end of the stop arm. With the stop arm extension in place, the stop arm is longer and desirably spans the height of the fence body. When the stop arm extension is removed, the remaining stop arm preferably spans the width of the fence body. Thus, the stop arm extension is preferably attached to the stop arm when the fence body is in the high-profile position and is desirably detached and/or removed from the stop arm when the fence body is in the low-profile position.

In one embodiment, the stop arm and the stop arm extension desirably form a tongue-in-groove assembly that provides enhanced stability when the stop arm extension is attached. In one embodiment, the stop arm and the stop arm extension desirably include respective apertures that are aligned with one another and that are adapted to receive a locking screw or fastener for attaching the stop arm extension to the stop arm.

In one embodiment, the fence body desirably has a length and the at least one stop assembly is securable to the fence body at a plurality of positions along the length of the fence body. In one embodiment, the at least one stop assembly is adapted for being slideably coupled with the fence body so as to slide along the length of the fence body until reaching a desired position on the fence body. The stop assembly may be locked in place at the desired location. In one embodiment, the fence body includes an elongated slot formed in at least one of the faces thereof and the at least one stop assembly is slideably coupled with the elongated slot. The at least one stop assembly may include a locking assembly that is moveable between a first state in which the at least one stop assembly is slideable within the elongated slot along the length of the fence body and a second state in which the at least one stop assembly is locked in place within the elongated slot along the length of the fence body.

In one embodiment, the at least one stop assembly desirably includes a main body having the stop arm rotatably connected therewith. The main body desirably has a bottom surface having a projection that is engageable with the elongated slot for slideably coupling the at least one stop assembly with the elongated slot.

In one embodiment, at least one of the elongated slots formed in the fence body extends along the entire length of the fence body so as to be accessible at the ends of the fence body. In one embodiment, the elongated slot is preferably a stepped elongated slot having an opening of a first width, a first section of a second width that is greater than the first width of the opening, and a third section having a width that is greater than the width of the second section. The stepped elongated slot desirably enables T-bolts and T-nuts to be secured within the elongated slots and then tightened for holding a tool such as a stop assembly or a clamp assembly to the fence body. The T-bolts and T-nuts may be inserted into the elongated slots at the open ends of the slots at the ends of the fence body.

In one embodiment, the locking assembly for the at least one stop assembly preferably includes a threaded T-bolt having a head extending below the projection at the bottom surface of the main body and a rotatable locking knob threadably coupled with an upper end of the threaded T-bolt. In one embodiment, the head of the threaded T-bolt is insertable into the elongated slot for slideably coupling the at least one stop assembly with the elongated slot. The rotatable locking knob may be rotated for drawing the head of the threaded T-bolt toward the projection at the bottom surface of the main body for locking the main body in place within the elongated slot.

In one embodiment, the at least one stop assembly preferably includes a plurality of stop assemblies securable to the fence body. Each of the stop assemblies preferably includes a stop arm that is moveable from a first position in which the stop arm overlies one of the faces of the fence body for functioning as a stop and a second position in which the stop arm extends away from one of the faces of the fence body for enabling a work piece to be advanced by the raised arm of the stop assembly. The stop arms of the plurality of stop assemblies desirably move independently of one another so that a first one of the stop arms may be moved into the second position while another one of the stop arms remains in the first position. The stop assemblies are also slideable independently of one another along the length of the fence body.

In one embodiment, the fence assembly desirably includes at least one clamping assembly for securing the fence body to the table top surface. The at least one clamping assembly is preferably coupled with the second elongated slot formed in the rear face of the fence body when the fence body is in the high-profile position and is coupled with the first elongated slot in the fence body top surface when the fence body is in the low-profile position.

In one embodiment, the at least one clamping assembly preferably includes a plurality of clamping assemblies adapted to slide within the elongated slots for adjusting the respective positions of the clamping assemblies along the length of the fence body. In one embodiment, the plurality of clamping assemblies are preferably adapted to engage T-slot grooves formed in a table of a power tool. The relative positions of the clamping assemblies within the elongated slot on the fence body may be adjusted for conforming to the space between two or more T-slot grooves formed in the table.

In one embodiment, each clamping assembly preferably includes a locking assembly for locking the clamping assembly at a selected location along the length of the fence body. In one embodiment, the locking mechanism includes a T-nut structure that is coupled with screws. The T-nut structure may be inserted into an elongated slot. The screws may be tightened for locking one of the clamping assemblies in place within one of the elongated slots.

In one embodiment, a fence assembly for a power tool having a work piece supporting table desirably includes a fence body securable to a top surface of the table, the fence body having front and rear faces having a distance therebetween that defines a width of the fence body and top and bottom faces having a distance therebetween that defines a height of the fence body. The fence body preferably has a high-profile position in which the front and rear faces are perpendicular to the table top and top and bottom faces are parallel with the table top, and a low-profile position in which the front and rear faces are parallel with the table top surface and the top and bottom faces are perpendicular to the table top surface.

In one embodiment, the fence assembly preferably includes two or more stop assemblies securable to the fence body. Each of the stop assemblies desirably includes a stop arm adapted to overlie one of the front and rear faces of the fence body when the fence body is in the high-profile position and one of the top and bottom faces of the fence body when the fence body is in the low-profile position. Each of the stop assemblies preferably has a stop arm extension attachable to the stop arm associated therewith for extending the length of the stop arm for use when the fence body is in the high-profile position.

In one embodiment, each stop arm is moveable from a first position in which the stop arm overlies one of the faces of the fence body for functioning as a stop and a second position in which the stop arm extends away from one of the faces of the fence body. When the stop arms are in the second position, a work piece may be advanced along a face of the fence body without being obstructed by the raised stop arms.

In one embodiment, the fence body has a length and the stop assemblies are securable to the fence body at a plurality of locations along the length of the fence body. In one embodiment, the stop assemblies are securable within a first elongated slot extending along the length of the fence body and clamping assemblies are securable with a second elongated slot extending along the length of the fence body.

These and other preferred embodiments of the present invention will be described in more detail below.

### BRIEF DESCRIPTION OF THE DRAWING

FIG. 1 shows a perspective view of a drill press, in accordance with one embodiment of the present invention.

FIG. 2 shows a perspective view of a fence body for a fence assembly, in accordance with one embodiment of the present invention.

FIG. 3 shows a right end view of the fence body shown in FIG. 2 with the fence body oriented in a high-profile position.

FIG. 4 shows a perspective view of a clamp assembly for a fence assembly, in accordance with one embodiment of the present invention.

FIG. 5 shows a pair of clamp assemblies similar to the clamp assembly shown in FIG. 4.

FIGS. 6A and 6B show a method of assembling the clamp assemblies of FIG. 5 with the fence body of FIGS. 2 and 3, in accordance with one embodiment of the present invention.

FIG. 7 shows a partially exploded view of a stop assembly for a fence assembly, in accordance with one embodiment of the present invention.

FIG. 8A shows the stop assembly of FIG. 7 in a high-profile configuration, in accordance with one embodiment of the present invention.

FIG. 8B shows the stop assembly of FIG. 7 in a low-profile configuration, in accordance with one embodiment of the present invention.

FIGS. 9A-9D show a method of assembling a fence assembly having a high-profile stop assembly with a table of a stationary woodworking tool, in accordance with one embodiment of the present invention.

FIG. 10 shows a right side view of the fence body and the high-profile stop assembly shown in FIG. 9D.

FIGS. 11A-11B show a method of assembling a fence assembly having a low-profile stop assembly with a table of a stationary woodworking tool, in accordance with one embodiment of the present invention.

FIG. 12 shows a right side view of the fence body and the low-profile stop assembly shown in FIGS. 11A-11B.

FIGS. 13A-13C show a schematic view of a method of using a fence assembly for drilling holes in a work piece, in accordance with one embodiment of the present invention.

FIGS. 14A-14B show a top plan schematic view of the method shown in FIGS. 13A-13C.

### DETAILED DESCRIPTION

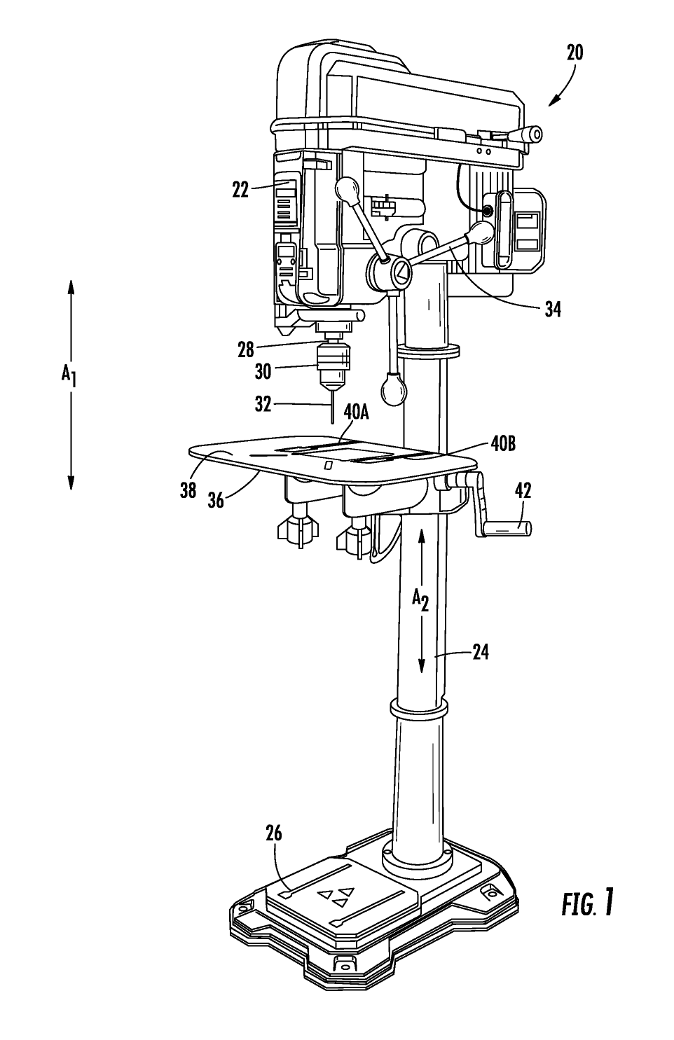

Referring to FIG. 1, in one embodiment, a drill press 20 preferably includes a head stock 22 supported atop a vertically-extending support column 24 and a stand 26 supporting a lower end of the support column. The drill press 20 desirably includes a rotatable spindle 28 projecting from a lower end of the head stock 22 and a chuck 30 mountable to a lower end of the spindle 28. The chuck 30 is preferably adapted to receive a drill bit 32 used for drilling holes in work pieces. Other tools may also be secured to the chuck 30 such as a sanding tool. The drill press 20 desirably includes a rotatable handle 34 that may be engaged by an operator for lowering the rotatable spindle 28, the chuck 30, and the drill bit 32 along a vertical axis A₁ that is parallel with a vertically-extending longitudinal axis A₂ of the support column 24. The drill press 20 also preferably includes a table 36 having a top surface 38 adapted to support work pieces below the spindle 28, the chuck 30, and the drill bit 32. The table 36 preferably includes a pair of T-slot grooves 40A, 40B that extend from a rear edge of the table 36 toward a front edge of the table. The pair of T-slot grooves 40A, 40B in the table 36 are desirably parallel to one another. The T-slot grooves 40A, 40B may be used for securing items, such as a fence, to the table 36. In one embodiment, the table 36 may be rotated about the longitudinal axis A₂ of the support column 24, or placed at a non-perpendicular angle relative to the longitudinal axis A₂ of the support column. The drill press 20 preferably includes a table handle 42 that may be operated for raising and lowering the table 36 using a rack and pinion arrangement.

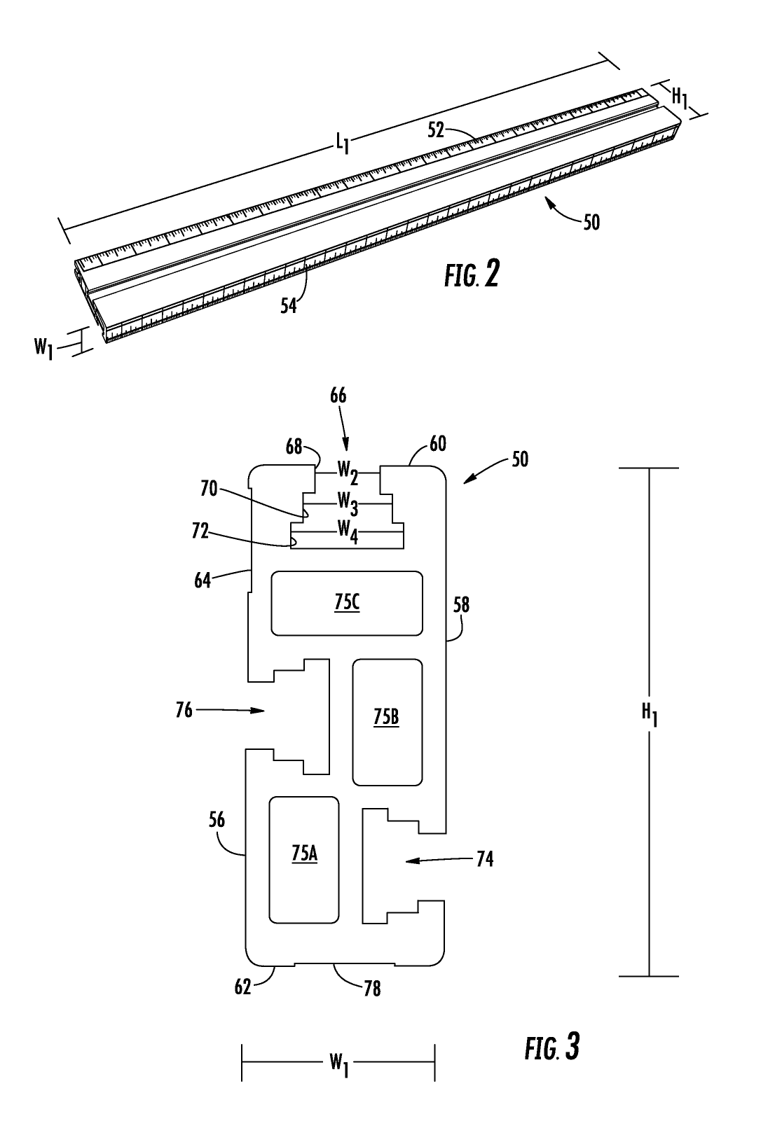

Referring to FIG. 2, in one embodiment, a fence assembly for the drill press shown in FIG. 1 includes a fence body 50 having a length L₁ of about 20-30 inches, and more preferably about 24 inches, a height H₁ of about 2-3 inches, and more preferably about 2.5 inches, and a width W₁ of about 0.5-1.5 inches, and more preferably about 1.0 inches. In one embodiment, the fence body 50 is made of a rugged material such as metal. In one embodiment, the fence body 50 is extruded, such as an extruded aluminum fence that is adapted to be used in different positions atop a table of a drill press for supporting drilling applications.

In one embodiment, the fence body 50 includes a first scale 52 extending along the length L₁ of the fence body, which is preferably used when the fence body 50 is in a high-profile configuration. The fence body 50 desirably includes a second scale 54 that also extends along the length L₁ of the fence body, which may be used when the fence body is in a low-profile configuration.

FIG. 3 shows a right side elevational view of the fence body 50 shown in FIG. 2, with the fence body 50 being in a high-profile configuration. In one embodiment, the fence body 50 includes a front face 56, a rear face 58, a top face 60 and a bottom face 62. The respective faces 56, 58, 60, 62 desirably extend along the length L₁ (FIG. 2) of the fence body 50. The distance between the front and rear faces 56, 58 defines the width W₁ of the fence body 50 and the distance between the top and bottom faces 60, 62 defines the height H₁ of the fence body.

The fence body front face 56 preferably includes first elongated groove 64 formed therein that extends along the length L₁ of the fence body. The first elongated groove 64 preferably extends along the upper end of the front face 56, which is adjacent the fence body top face 60. The first elongated groove is adapted to receive the first scale 52 (FIG. 2).

The fence body top face 60 also desirably includes a first stepped T-slot 66 that extends along the length L₁ of the fence body 50. The first stepped T-slot 66 preferably has an opening 68 defining a width W₂ of about 0.34″, a first region 70 having a width W₃ of about 0.45″, and a second region 72 having a width W₄ of about 0.57″. In one embodiment, the first stepped T-slot 66 is adapted to receive T-nuts and/or T-bolts used for assembling tools with the fence body 50.

In one embodiment, the fence body 50 desirably includes a second stepped T-slot 74 that is formed in the fence body rear face 58. The second stepped T-slot 74 desirably extends along the length L₁ of the fence body and is located adjacent the fence body bottom face 62. The second stepped T-slot 74 preferably has the same configuration as the first stepped T-slot 66 described above and includes an opening, a first region, and a second region. Like the first stepped T-slot 66, the second stepped T-slot 74 is adapted to receive T-nuts and T-bolts for assembling tools with the fence body 50.

The fence body 50 also desirably includes a third stepped T-slot 76 formed in the fence body front face 56. The third stepped T-slot 76 desirably extends along the length L₁ of the fence body 50, is generally in a center of the fence body front face 56, and has a shape and configuration similar to the first and second stepped T-slots 66, 74. In one embodiment, the third stepped T-slot 76 may be used for facilitating clamping of a sacrificial wear surface. In one embodiment, the third stepped T-slot 76 may be used to extend the vertical face of the fence by attaching an additional member to the face of the fence where additional height of the fence is desired.

The fence body 50 also desirably includes a second elongated groove 78 formed in the bottom face 62 of the fence body 50. The second elongated groove 78 desirably extends along the length L₁ of the fence body and is adapted to receive the second scale 54 (FIG. 2) therein.

In one embodiment, the fence body 50 preferably has elongated openings 75A-75C extending along the length thereof that are designed to remove excess material from the fence body and make the fence body lighter.

Referring to FIG. 4, in one embodiment, a drill press fence assembly includes a clamp assembly that is adapted for being coupled with the fence body 50 shown in FIGS. 2 and 3 of the present application. The clamp assembly 80 desirably includes a horizontal clamping flange 82 having a top surface 84 and a substantially flat bottom surface 86. The clamp assembly 80 also desirably includes a vertical clamping flange 88 that is connected with the horizontal clamping flange 82. The vertical flange desirably includes an inner face 90 and an outer face 92 having an elongated projection 94 extending the length thereof. As will be described in more detail herein, the elongated projection 94 is adapted to be seated within the opening 68 of one of the stepped T-slots 66, 74, 76 of the fence body 50 (FIG. 3).

The clamp assembly 80 also preferably includes a T-nut 96 that opposes the elongated projection 94 of the vertical clamping flange 88. The clamp assembly 80 includes first and second screws 98A, 98B that are adapted to pass through the vertical clamping flange 88 for engaging the T-nut 96. The screws 98A, 98B may be rotated for bringing the T-nut 96 closer to and further away from the opposing elongated projection 94. In one embodiment, the screws 98A, 98B are rotated in a clockwise direction for securing the T-nut 96 and the vertical clamping flange 88 to one of the T-slots 66, 74, 76 of the fence body (FIG. 3).

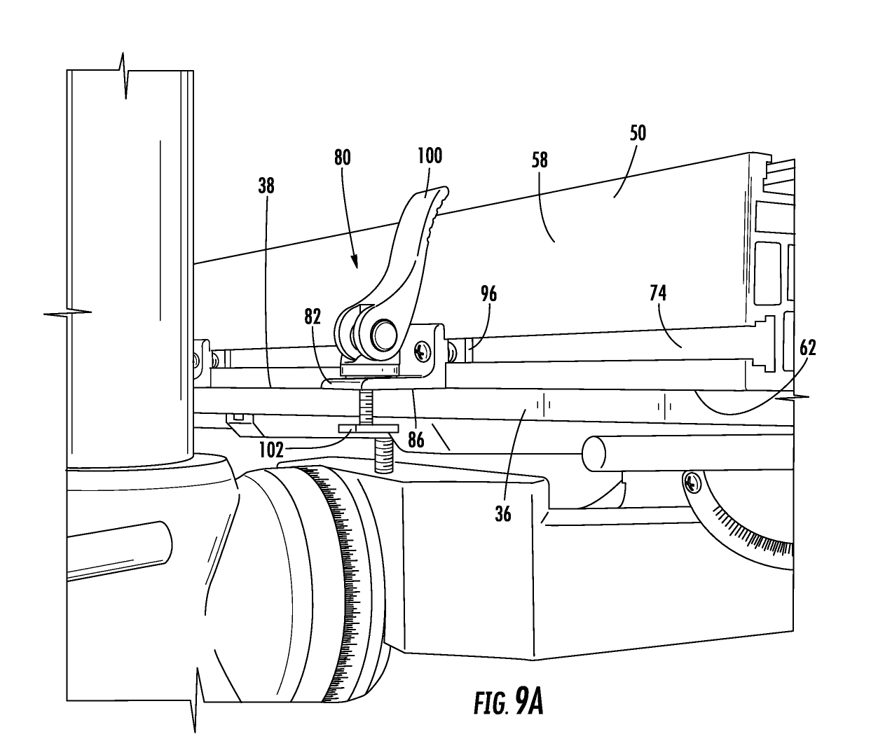

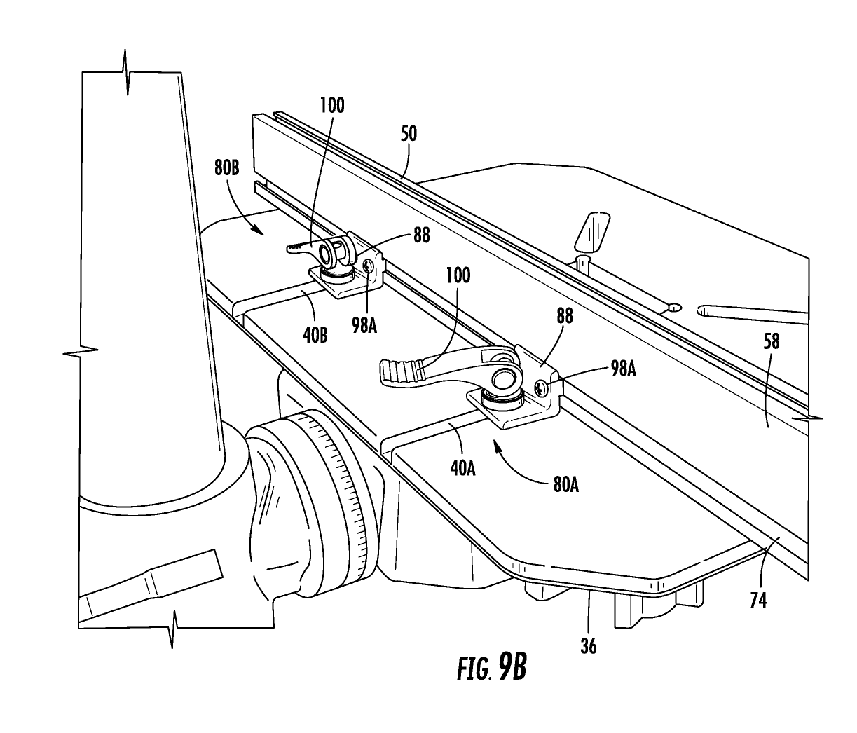

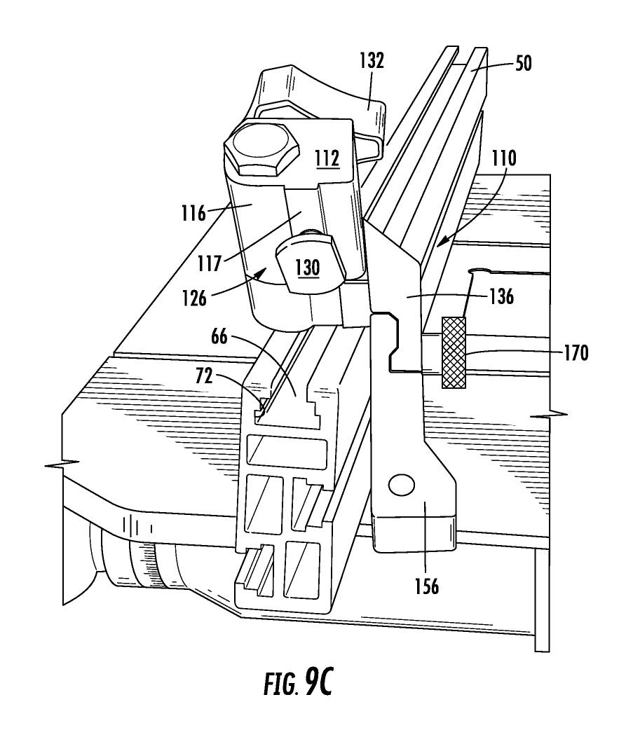

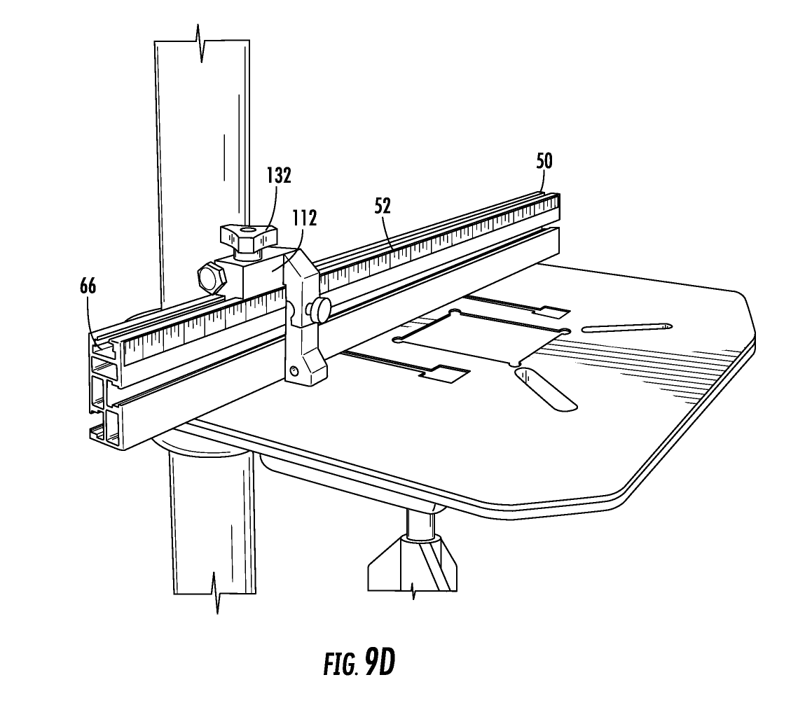

The clamp assembly 80 also desirably includes a handle 100 having a cam surface. The handle 100 is interconnected with a T-bolt 102 (FIG. 9A) that projects below the bottom surface 86 of the horizontal clamping flange 82. The handle 100 is rotatable between an upright configuration in which the T-bolt is further away from the bottom surface 86 of the horizontal clamping flange 82 and a second locked position in which the T-bolt 102 is closer to the bottom surface 86 of the horizontal clamping flange 82. The handle 100 may also be pivoted in a clockwise direction about the T-bolt 102 for providing further clamping force through the T-bolt 102. In one embodiment, as the handle 100 is pivoted in a clockwise direction about the T-bolt 102, the T-bolt moves closer to the bottom surface 86 of the horizontal clamping flange for further tightening the clamp assembly.

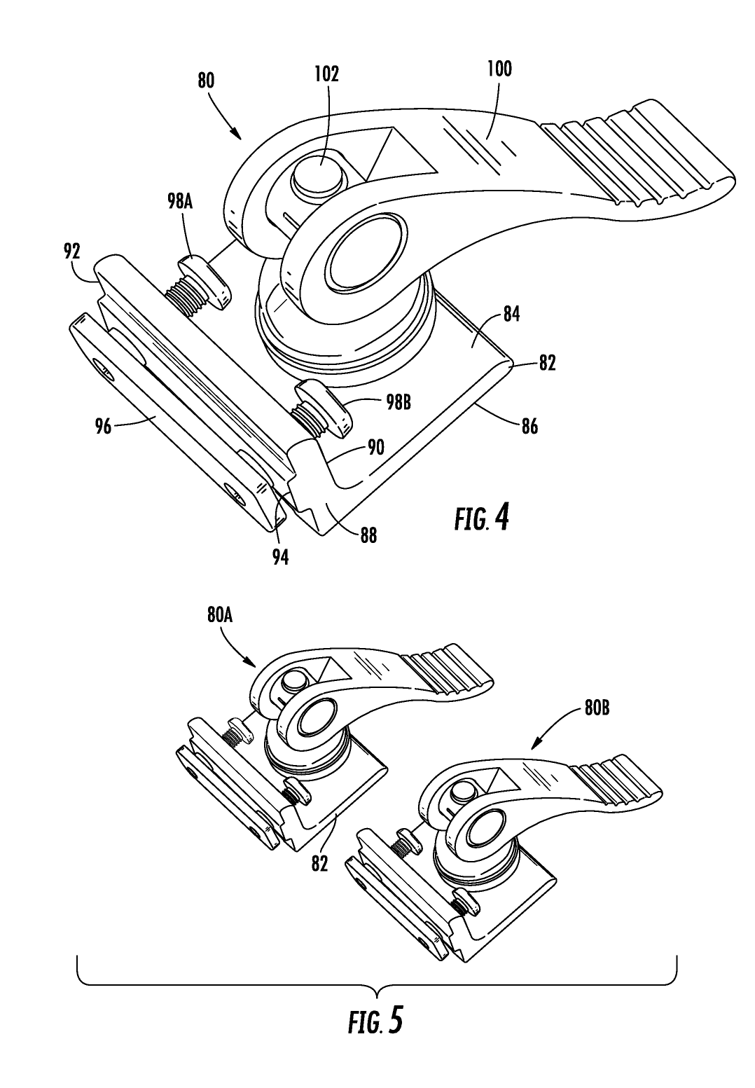

Referring to FIG. 5, in one embodiment, a pair of clamp assemblies 80A, 80B are provided. Both of the clamp assemblies 80A, 80B have the features shown and described above in FIG. 4. The two clamp assemblies 80A, 80B are adapted to be assembled with a fence body (FIGS. 2-3) for attaching the fence body to a table 36 of a drill press 20 (FIG. 1). The T-bolts 102 (FIG. 9A) projecting from the bottoms of the horizontal flanges preferably slide within the T-slot grooves 40A, 40B in the table 36 (FIG. 1).

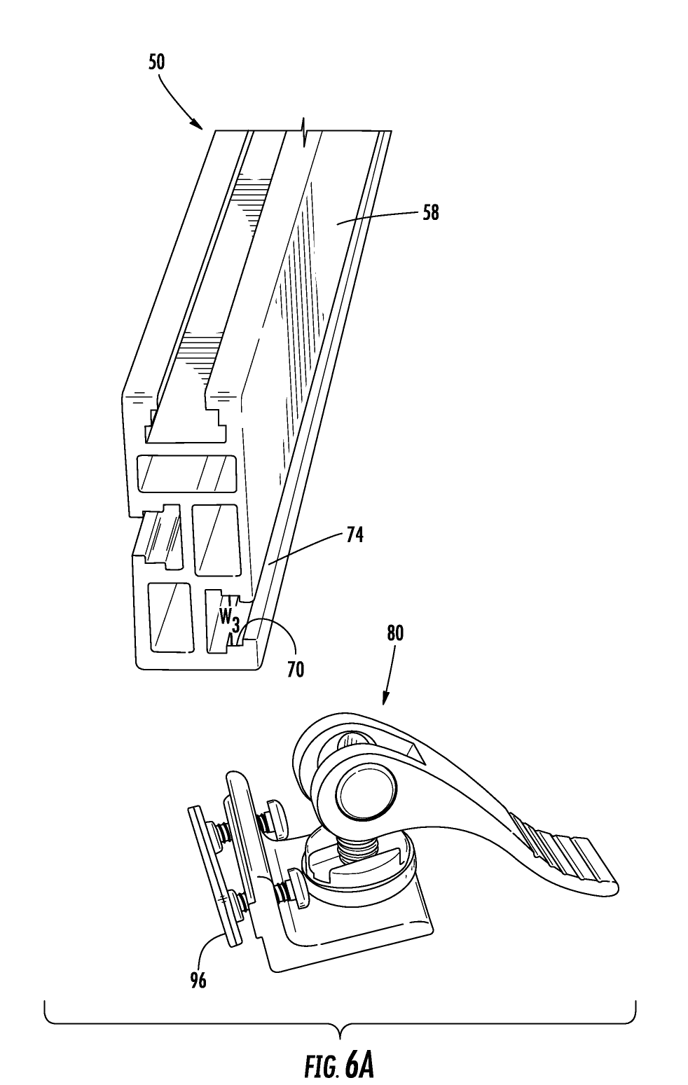

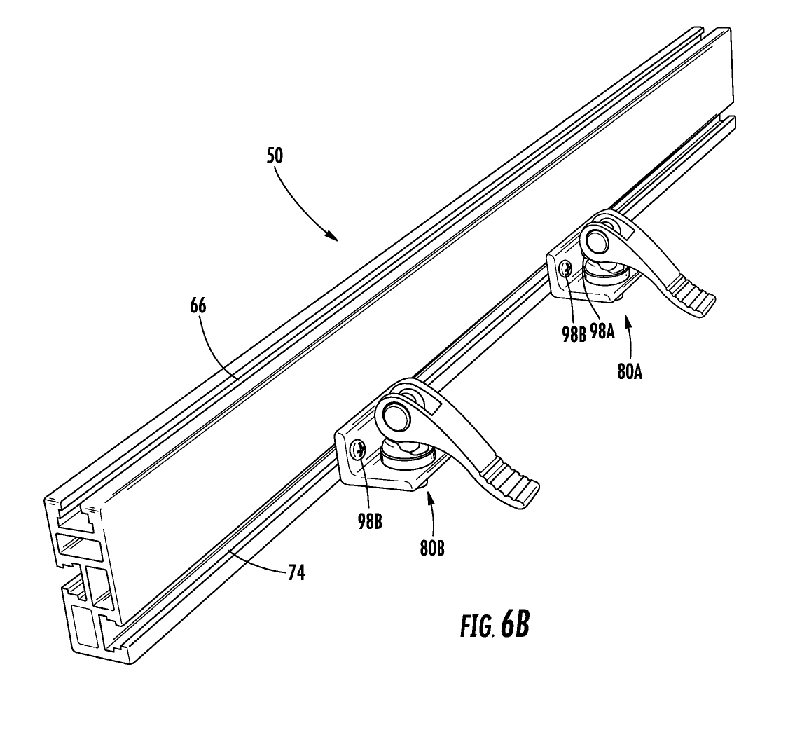

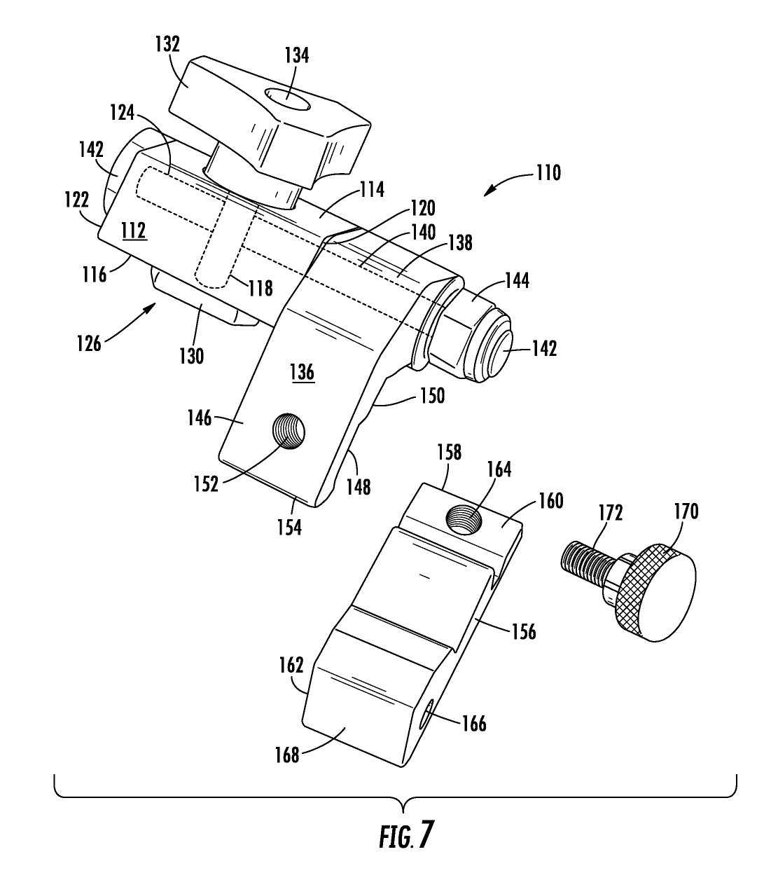

Referring to FIG. 6A, in one embodiment, a clamp assembly 80 is placed adjacent the rear face 58 of the fence body 50. The T-nut 96 is positioned adjacent the second stepped T-slot 74 at the end of the fence body. In the particular embodiment shown in FIG. 6A, the T-nut 96 has a height that matches the width W₃ of the first section 70 of the second stepped T-slot 74.

Referring to FIG. 6B, in one embodiment, the T-nuts 96 (6A) of both the first clamp assembly 80A and the second clamp assembly 80B are slid into an end of the second stepped T-slot 74, and are desirably centered within the second stepped T-slot 74 of the fence body 50. After the first and second clamp assemblies 80A, 80B are inserted into the second T-slot 74, the fence body 50 is configured for being used in a high-profile configuration. The first stepped T-slot 66 will be used for connecting with one or more stop assemblies (not shown) with the fence body 50, as will be described in more detail herein. After the clamp assemblies are slid to a desired located within the second elongated slot, the screws 98A, 98B are tightened for locking the clamp assemblies in place.

Referring to FIG. 7, in one embodiment, at least one stop assembly 110 is used in conjunction with the fence body for aligning work pieces atop the table 36 (FIG. 1). The stop assembly 110 is preferably adapted to be coupled with the fence body 50 (FIG. 3). In one embodiment, the stop assembly 110 preferably includes a main body 112 having a top face 114, a bottom face 116 and a first aperture 118 extending between the top and bottom faces 114, 116. The main body 112 also desirably includes a first end face 120, a second end face 122 and a second aperture 124 extending between the first and second end faces 120, 122. The first aperture 118 is preferably offset from the second aperture 124 so that it does not intersect the second aperture.

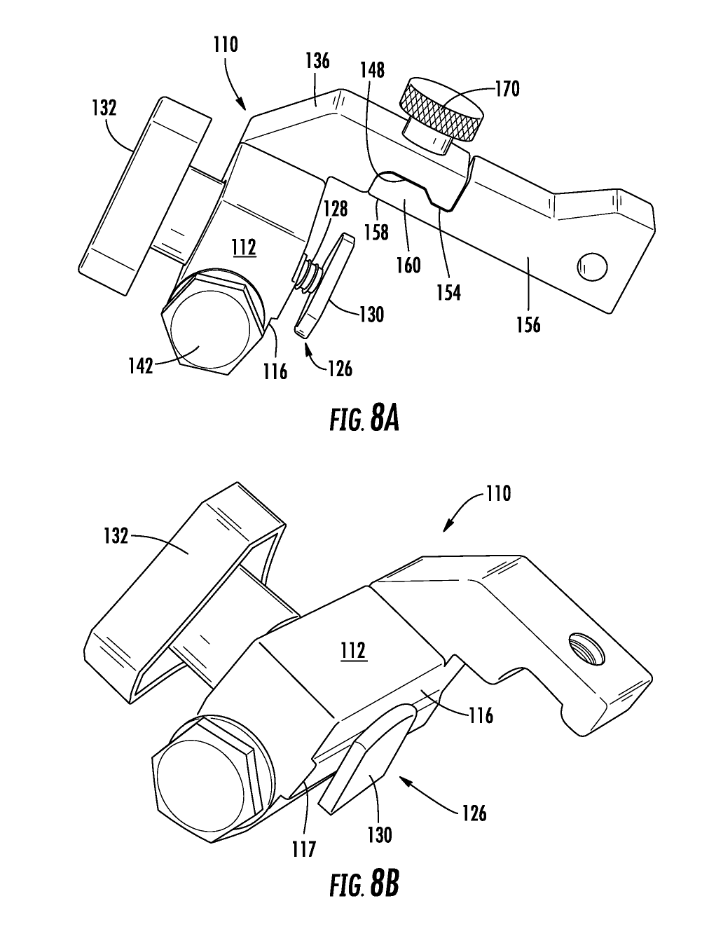

The stop assembly 110 desirably includes a T-bolt 126 including a threaded shaft 128 (FIG. 8A) and a head 130 connected to a lower end of the threaded shaft 128. The stop assembly 110 preferably includes a tightening knob 132 having an internally threaded opening 134 adapted to mesh with an upper end of the threaded shaft of the T-bolt 126. In one embodiment, the threaded shaft 128 (FIG. 8A) is adapted to pass through the first aperture 118 for being coupled with the internal threads 134 of the tightening knob 132. The tightening knob 132 may be rotated in a first direction for bringing the head 130 of the T-bolt 126 closer to the bottom surface 116 of the main body 112. The tightening knob 132 may be rotated in an opposite direction for loosening the T-bolt 126. The T-bolt 126 is preferably adapted to be received within one of the stepped T-slots of the fence body for securing the stop assembly 110 with the fence body.

In one embodiment, the stop assembly 110 desirably includes a stop arm 136 that is coupled with the main body 112. In one embodiment, the stop arm 136 desirably includes an upper end 138 and a first aperture 140 that extends adjacent the upper end 138. The stop arm 136 is coupled with the main body 112 by a hex bolt 142 having a shaft that passes through the main body second aperture 124 and the stop arm first aperture 140. A locking nut 144 is desirably secured over the distal end of the shaft of the hex bolt 142. The stop arm 136 desirably includes a lower end 146 having a groove 148 formed in a rear face 150 thereof. The stop arm 136 also desirably includes a second aperture 152 that extends from a front face 154 of the lower end 146 of the stop arm 136 to the groove 148 formed in the rear face 150.

The stop assembly 110 also desirably includes a stop arm extension 156 including an upper end 158 having a tongue 160 and a lower end 162. The stop arm extension 156 preferably includes a first internally threaded aperture 164 adjacent the upper end 158 and a second transverse aperture 166 adjacent the lower end 162. The lower end 162 of the stop arm extension 156 includes a substantially flat bottom surface 168 adapted to oppose the top surface 38 of the table 36 of the drill press 20 (FIG. 1).

The stop assembly 110 also desirably includes a knurled thumb screw 170 having a threaded shaft 172 adapted to be inserted through the stop arm second aperture 152 for meshing with the internally threaded aperture 164 adjacent the upper end 158 of the stop arm extension 156. The knurled thumb screw 170 is desirably utilized for securing the stop arm extension 156 with the stop arm 136 to provide a stop assembly 110 having a high-profile configuration.

FIG. 8A shows the stop arm extension 156 assembled with the stop arm 136. The tongue 160 at the upper end 158 of the stop arm extension 156 preferably meshes with the groove 148 provided in the rear surface 154 of the stop arm 136. The threaded shaft (not shown) of the knurled thumb screw 170 preferably connects the stop arm extension 156 with the stop arm 136. The stop assembly 110 also desirably includes the tightening knob 132 that is coupled with the T-bolt 126. The threaded shaft 128 preferably passes through the main body 112 of the stop assembly 110 for meshing with the internally threaded opening 134 (FIG. 7) of the tightening knob 132. In one embodiment, the tightening knob 132 is rotated in a clockwise direction for bringing the head 130 of the T-bolt 126 closer to the bottom surface 116 of the main body 112. In one embodiment, the stop arm 136 is rotatable relative to the main body 112 due to the connection formed by the hex bolt 142.

FIG. 8B shows the stop assembly 110 in a low-profile configuration whereby the stop arm extension 156 (FIG. 8A) has been removed. In the embodiment of FIG. 8B, the lower surface 116 of the main body has an elongated projection 117 formed thereon. The elongated projection 117 is adapted to fit within the opening 68 of one of the stepped T-slots 66, 74, 76 of the fence body 50 (FIG. 3). In one embodiment, the elongated projection 117 is insertable into the opening of the first stepped T-slot 66 (FIG. 3) of the fence body for use in a high-profile configuration, and is insertable into the second stepped T-slot 74 of the fence body 50 (FIG. 3) when the fence is used in a low-profile configuration.

The drill press fence of the present invention may be positioned atop a table in either a high-profile configuration or a low-profile configuration. FIG. 9A illustrates an exemplary embodiment of a drill press assembly wherein the drill press fence is positioned on a top surface 38 of a table 36 in a high-profile configuration wherein the fence body bottom face 62 abuts against the top surface 38 of the table 36. One or more of the clamping assemblies 80 may be coupled with the fence body 50 by sliding the T-nuts 96 of the clamp assemblies 80 into the second stepped T-slots 74 formed in the rear face 58 of the fence body 50.

FIGS. 9A and 9B illustrate an embodiment of the fence assembly after the first and second clamp assemblies 80A, 80B are connected with the second stepped T-slot 74 of the fence body 50. The T-bolts 102 of the first and second clamp assemblies 80A, 80B are slid within the respective T-slot grooves 40A, 40B formed in the table 36. The handle 100 of the clamp assembly 80 is preferably in an upright position so that the head of the T-bolt 102 is spaced from the bottom surface 86 of the horizontal clamp flange 82, which enables the clamp assemblies to be moved within the T-slot grooves. The clamp assemblies 80A, 80B and the fence body 50 are advanced within the T-slot grooves toward the front edge of the table 36 until the fence body reaches a desired position.

With the cam-action handles 100 in an upright position (FIG. 9A), the T-bolt 102 of the clamp assembly 80 is slid into the T-slot groove 40A in the table 36. The fence body 50 and the mounting clamp assemblies 80A, 80B are slid forward in the T-slot grooves 40A, 40B to a desired location on the table 36. The fence body 50 may now be slid in a direction perpendicular to the T-slot grooves 40A, 40B to place it in the center of the table, or at another desired position. The two tightening screws 98A, 98B extending through the vertical clamp flange 88 are tightened so that the fence body may no longer slide laterally relative to the clamp assembly. The tightening screws 98A, 98B on the second clamp assembly 80B are also tightened. The cam-action handles 100 may be rotated into the downward position as shown in FIG. 9B to prevent further sliding of the clamp assemblies 80A, 80B in the T-shaped grooves 40A, 40B in the table 36 so as to lock the fence body 50 atop the table 36.

FIG. 9C illustrates an embodiment of the fence assembly in which the stop assembly 110 (with the stop arm extension 156 connected with the stop arm 136) is assembled with the fence body 50. The stop arm extension 156 is held to the stop arm 136 using the knurled thumb screw 170. The tightening knob 132 is loosened so that the head 130 of the T-bolt 126 is spaced from the elongated groove 117 extending along the bottom surface 116 of the main body 112. The head 130 of the T-bolt 126 is insertable into the first stepped T-slot 66. The head 130 fits into the second region 72 of the first stepped T-slot 66. Referring to FIG. 9D, after the head 130 of the T-bolt 126 is slid into the first stepped T-slot 66 of the fence body 50, the main body 112 may be slid along the length of the fence body 50 to a desired location along the first scale 52.

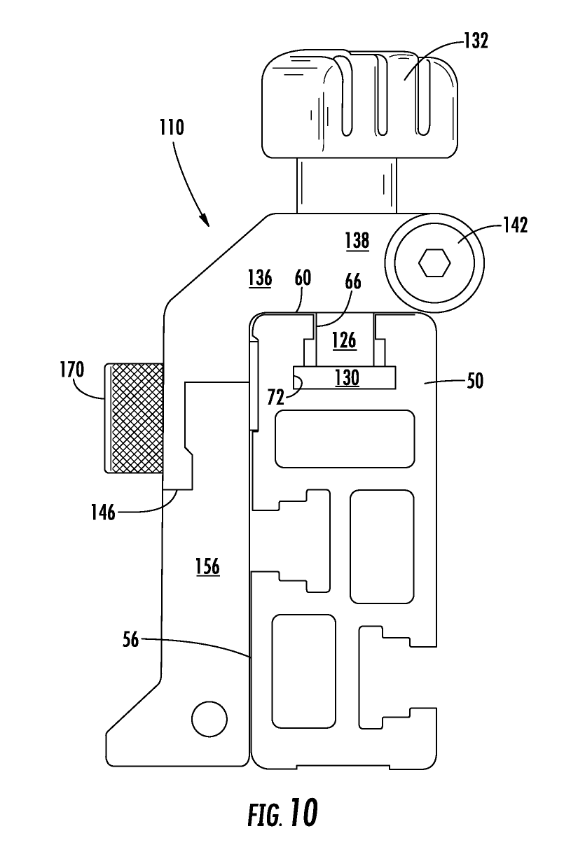

Referring to FIGS. 9C-9D and 10, in one embodiment, the tightening knob 132 may be rotated in a clockwise direction for abutting the head 130 of the T-bolt 126 against the elongated projection 117 extending along the bottom surface 116 of the main body 112. As the tightening knob 132 is rotated in an opposite, counter-clockwise direction, the head 130 is able to move away from the elongated projection 117 of the bottom surface 116 of the main body 112. In one embodiment, when the handle 132 is loosened, the stop assembly 110 is free to slide in one of the T-slots 66, 74, 76 (FIG. 3). The stop assembly 110 may be locked in place within one of the T-slots by tightening the tightening knob 132.

FIG. 10 shows a right side sectional view of the stop assembly 110 after it has been assembled with the fence body 50. The head 130 of the T-bolt 126 of the stop assembly meshes with the second section 72 of the first stepped T-slot 66 formed in the top face 60 of the fence body 50. The tightening knob 132 is rotated in a clockwise direction for pulling the head 130 toward the upper-most extent of the second region 72 of the first stepped T-slot 66. The upper end 138 of the stop arm desirably overlies the top face 60 of the fence body 50 and the lower end 146 of the stop arm extends over the front face 56 of the fence body 50. The stop arm extension 156, which is connected with the stop arm 136 using the knurled thumb screw 170, also extends over the front face 56 of the fence body 50.

In one embodiment, the stop arm 136 and the stop arm extension 156 connected therewith may be moved into an extended position as shown in FIG. 10 for acting as a physical stop along the front face 56 of the fence body 50. The stop arm extension 156 and stop arm 136 may be moved into a retracted position by rotating the stop arm 136 in a clockwise direction about the hex bolt 142. The stop arm 136 may be repeatedly rotated between the extended position for functioning as a stop and a retracted position when not functioning as a stop.

Referring to 11A, in one embodiment, the drill press fence may be used in a low-profile configuration. In an exemplary embodiment, the clamp assemblies 80A, 80B shown and described above in FIGS. 4 and 5 are inserted into the first stepped T-slot 66 formed in the top face 60 of the fence body 50. As described above, the T-nuts 96 (FIG. 4) of the clamp assemblies 80A, 80B are slid into the first stepped T-slot 66 and generally centered along the length of the fence body 50. The T-bolts 102 (FIG. 4) projecting from the bottom surface 86 of the horizontal clamping flange 82 are slid into the T-slot grooves 40A, 40B (FIG. 9B) provided in the table of the drill press.

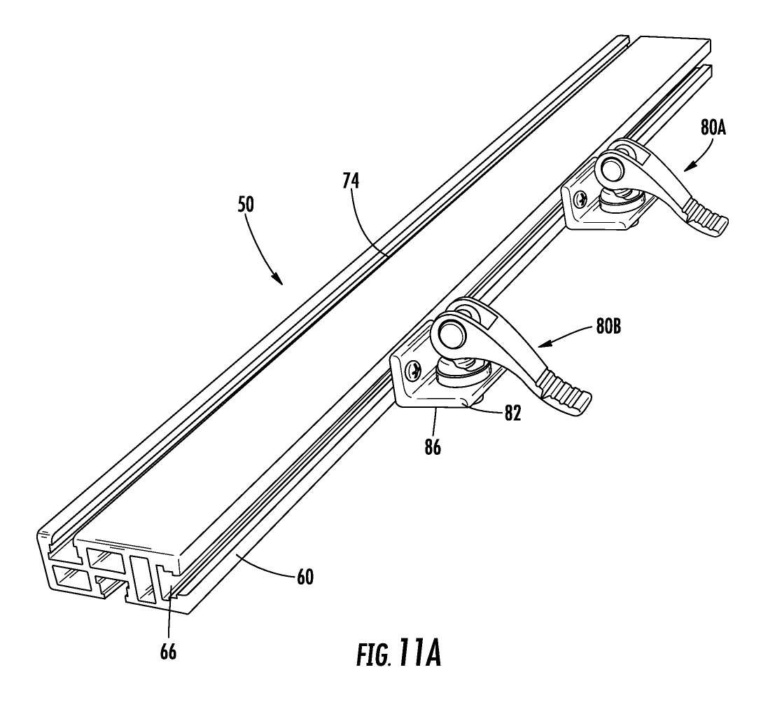

Referring to FIGS. 11A and 11B, the T-bolts of the clamping assemblies 80A, 80B are then slid forward in the T-slot grooves 40A, 40B of the table 36. A stop assembly 110, in a low-profile configuration with the stop arm extension removed, may be coupled with the second stepped T-slot 74 extending along the length of the fence body 50. The stop assembly 110 may be slid along the length of the fence body 50 to a desired location relative to the second scale 54 on the fence body 50. When a desired location along the scale 54 is achieved, the tightening knob 132 may be rotated for securing the position on the stop assembly 110 relative to the fence body 50. The stop arm 136 of the stop assembly 110 may be repeatedly rotated between the down, engaging position shown in FIG. 11B and an upright, non-engaging position where the stop arm 136 is away from the fence body bottom face 62.

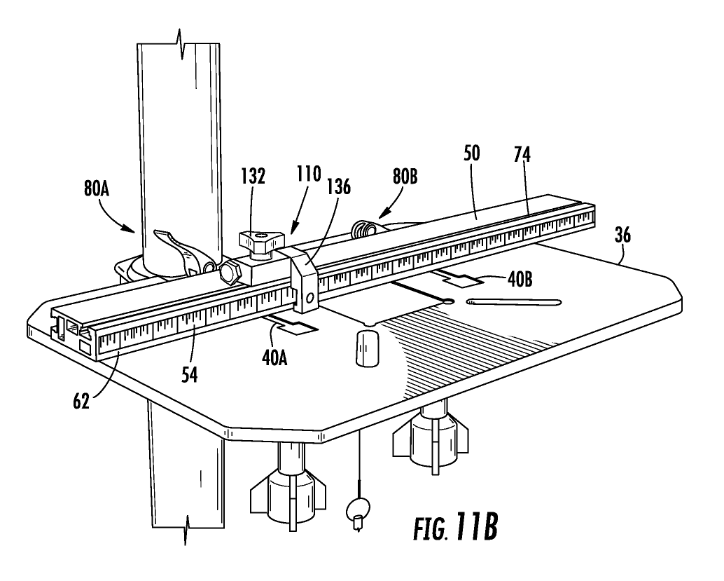

FIG. 12 shows a right side section view of the drill press fence shown in FIG. 11B. The fence body 50 is positioned on the table top surface 38 so that the front face 56 of the fence body rests on the table top surface 38. The stop assembly 110, in a low-profile configuration, is attached to the fence body 50. The head 130 of the T-bolt 126 of the stop assembly 110 is seated within the second region 72 of the second stepped T-slot 74. The upper end 138 of the stop arm 136 opposes the rear face 58 of the fence body 50 and the lower end 146 of the stop arm 136 opposes the bottom face 62 of the fence body 50. The stop arm may be rotated between the down, engaging position shown in FIG. 12 and an up, non-engaging position in which the lower end 146 of the stop arm 136 is moved away from the bottom face 62 of the fence body 50. The first stepped T-slot 66 may receive one or more clamp assemblies 80A, 80B (FIG. 5) for securing the fence body 50 to the table.

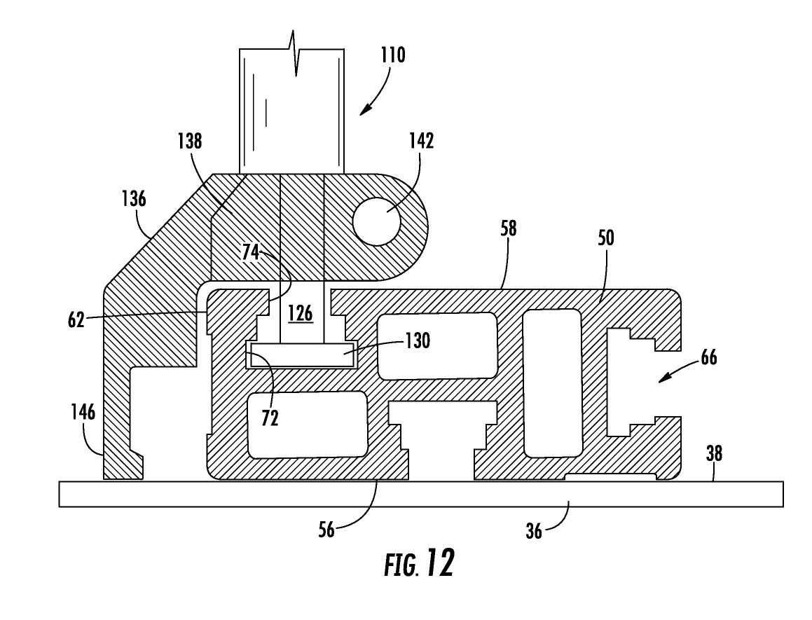

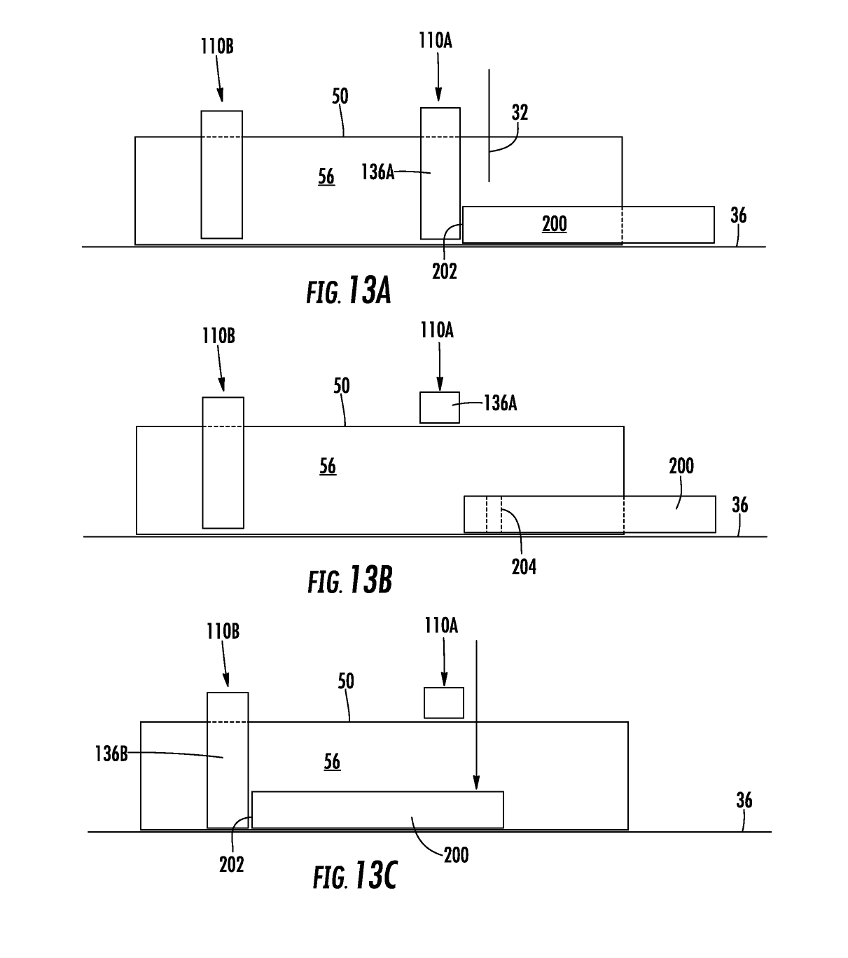

Referring to FIGS. 13A-13C, in one embodiment, a work piece 200 is placed atop a table 36 so that a series of holes may be drilled in the work piece. The work piece 200 is placed against a fence assembly including a fence body 50 having a pair stop assemblies 110A, 110B. The first stop assembly 110A includes a stop arm 136A that is positioned so that it overlies a front face 56 of the fence body 50. The work piece 200 is advanced toward the stop arm 136A of the first stop assembly 110A until a leading edge 202 abuts the first stop arm 136A. A first hole 204 may be drilled in the work piece 200 by lowering a drill bit into the work piece.

Referring to FIG. 13B, after the first hole 204 is drilled in the work piece 200, the first stop arm 136 is rotated up and away from the front face 56 of the fence body 50. Referring to 13C, with the first stop arm 136A in a non-engaging position, the leading edge 202 of the work piece 200 may be advanced to the second stop arm 136B of the second stop assembly 110B. The lowered second stop arm 136B halts further advance of the work piece 200 so that a second hole may be drilled in the work piece. Although only two stop assemblies 110A, 110B are shown in FIGS. 13A-13C, in other embodiments, additional stop assemblies may be utilized for forming a series of holes in a work piece.

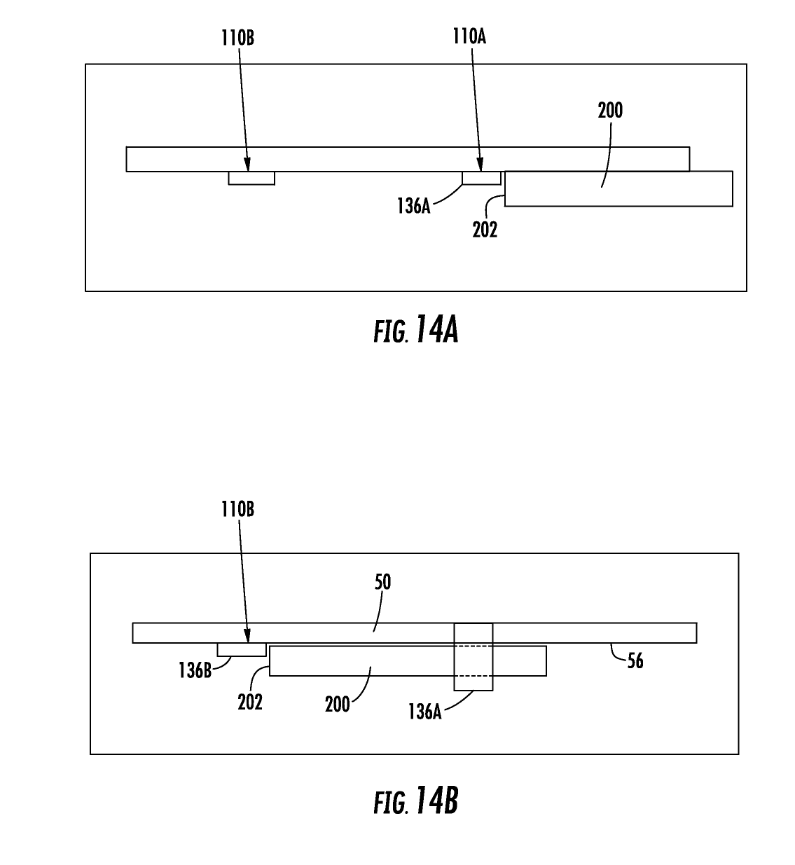

FIG. 14A shows a top plan view of FIG. 13A. The first stop arm 136 of the first stop assembly 110A is lowered for halting advancement of the leading edge 202 of the work piece 200. In FIG. 14B, the first stop arm 136A has been rotated away from the front face 56 of the fence body 50 so that the leading edge 202 of the work piece 200 may be advanced to the second stop arm 136B of the second stop assembly 110B. The second stop arm 136B is lowered for halting further advancement of the work piece 200 so that a second drill hole may be formed therein.

The headings used herein are for organizational purposes only and are not meant to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

While the foregoing is directed to embodiments of the present invention, other and further embodiments of the invention may be devised without departing from the basic scope thereof, which is only limited by the scope of the claims that follow. For example, the present invention contemplates that any of the features shown in any of the embodiments described herein, or incorporated by reference herein, may be incorporated with any of the features shown in any of the other embodiments described herein, or incorporated by reference herein, and still fall within the scope of the present invention.

What is claimed is:

1. A fence assembly for a power tool having a work piece supporting table comprising:
a fence body secureable to said table, said fence body having a front face and a rear face that define a width of said fence body and a top face and a bottom face that define a height of said fence body;
at least one stop assembly secureable to said fence body, each said stop assembly including a stop arm that is moveable from a first position in which said stop arm overlies one of said faces of said fence body and a second position in which said stop arm extends away from the one of said faces of said fence body.

2. The fence assembly as claimed in claim 1, wherein said stop arm is rotatable between said first and second positions.

3. The fence assembly as claimed in claim 2, wherein said fence body is secureable to said table in a high-profile position in which said front and rear faces are perpendicular to a top surface of said table and said top and bottom faces are parallel with said top surface of said table, and in a low-profile position in which said front and rear faces are parallel with said top surface of said table and said top and bottom faces are perpendicular to said top surface of said table.

4. The fence assembly as claimed in claim 3, wherein said top face of said fence body has an elongated slot formed therein along a length of said top face for slideably coupling said at least one stop assembly with said fence body when said fence body is in the high-profile position and said rear face of said fence body has an elongated slot formed therein along the length of said rear face for slideably coupling said at least one stop assembly with said fence body when said fence body is in the low-profile position.

5. The fence assembly as claimed in claim 3, wherein said stop arm of said at least one stop assembly is adapted to overlie said front face when said fence body is in the high-profile position and said bottom face when said fence body is in the low-profile position.

6. The fence assembly as claimed in claim 5, wherein said at least one stop assembly further comprises a stop arm extension attachable to said stop arm for extending the length of said stop arm for use when said fence body is in the high-profile position.

7. The fence assembly as claimed in claim 6, wherein said stop arm and said stop arm extension comprise a tongue-in-groove structure for attaching said stop arm extension to said stop arm.

8. The fence assembly as claimed in claim 3, wherein said fence body has a length and said at least one stop assembly is secureable to said fence body at a plurality of positions along the length of said fence body.

9. The fence assembly as claimed in claim 8, wherein said at least one stop assembly is adapted for being slideably coupled with said fence body for sliding along the length of said fence body.

10. The fence assembly as claimed in claim 9, wherein said fence body comprises an elongated slot formed in at least one of said faces of said fence body for slideably coupling said at least one stop assembly with said fence body.

11. The fence assembly as claimed in claim 10, wherein said at least one stop assembly comprises a locking assembly moveable between a first state in which said at least one stop assembly is slideable within said elongated slot along the length of said fence body and a second state in which said at least one stop assembly is locked in place within said elongated slot along the length of said fence body.

12. The fence assembly as claimed in claim 11, said at least one stop assembly further comprising a main body having said stop arm rotatably connected therewith, said main body having a bottom surface having a projection engageable with said elongated slot for slidably coupling said at least one stop assembly with said elongated slot.

13. The fence assembly as claimed in claim 12, wherein said locking assembly further comprises a threaded T-bolt having a head extending below said projection at said bottom surface of said main body and a rotatable locking knob threadably coupled with an upper end of said threaded T-bolt, wherein said head of said threaded T-bolt is insertable into said elongated slot for slidably coupling said at least one stop assembly with said elongated slot.

14. The fence assembly as claimed in claim 1, wherein said at least one stop assembly comprises a plurality of stop assemblies secureable to said fence body, each said stop assembly including a stop arm that is moveable from a first position in which said stop arm overlies one of said faces of said fence body for functioning as a stop and a second position in which said stop arm extends away from the one of said faces of said fence body.

15. The fence assembly as claimed in claim 14, wherein said stop arms of said stop assemblies move independently of one another so that a first one of said stop arms is positioned into the second position while another one of said stop arms is positioned in the first position.

16. The fence assembly as claimed in claim 4, further comprising at least one clamping assembly for securing said fence body over said top surface of said table, wherein said at least one clamping assembly is coupled with said second elongated slot formed in said rear face of said fence body when said fence body is in the high-profile position and is coupled with said first elongated slot formed in said top surface of said fence body when said fence body is in the low-profile position.

17. The fence assembly as claimed in claim 16, wherein said at least one clamping assembly comprises a plurality of clamping assemblies adapted to slide within said elongated slots for adjusting the respective positions of said clamping assemblies along the length of said fence body.

18. The fence assembly as claimed in claim 17, wherein each said clamping assembly includes a locking mechanism for locking said clamping assembly at a selected location along the length of said fence body.

19. A fence assembly for a power tool having a work piece supporting table comprising:
a fence body secureable to a top surface of said table, said fence body having front and rear faces that define a width of said fence body and top and bottom faces that define a height of said fence body, said fence body having a high-profile position in which said front and rear faces are perpendicular to said table top surface and said top and bottom faces are parallel with said table top surface, and a low-profile position in which said front and rear faces are parallel with said table top surface and said top and bottom faces are perpendicular to said table top surface;
two or more stop assemblies secureable to said fence body, each said stop assembly including a stop arm adapted to overlie one of said front and rear faces of said fence body when said fence body is in the high-profile position and one of said top and bottom faces of said fence body when said fence body is in the low-profile position, wherein each said stop assembly has a stop arm extension attachable to said stop arm associated therewith for extending the length of said stop arm for use when said fence body is in the high-profile position.

20. The fence assembly as claimed in claim 19, wherein each said stop arm is moveable from a first position in which said stop arm overlies one of said fence body faces for functioning as a stop and a second position in which said stop arm extends away from the one of said fence body faces.

21. The fence assembly as claimed in claim 20, wherein said fence body has a length and said stop assemblies are secureable to said fence body at a plurality of locations along the fence body length.

22. A fence for a stationary woodworking tool comprising:
a fence body having a generally rectangular cross section and having a front face and a parallel, opposing rear face and a top face and parallel, opposing bottom face, the top and bottom faces being perpendicular to the front and rear faces;
the front, rear, top and bottom faces having a length defining the length of the fence body;
a first slot in the front face adjacent to the bottom face, extending the entire length of the front face;
a second slot in the top face, extending the entire length of the top face;
a third slot in the rear face, generally in a mid-section of the rear face, extending the entire length of the rear face.
